(19) United States
(12) Patent Application Publication
(10) Pub. No.: US 2012/0166228 A1
(43) Pub. Date: Jun. 28, 2012

(54) COMPUTER-IMPLEMENTED SYSTEMS AND METHODS FOR PROVIDING AUTOMOBILE INSURANCE QUOTATIONS

(75) Inventors: Joseph P. Singleton, Olmsted Township, OH (US); Michael A. Zukerman, Solon, OH (US); Randi J. Anderson, Reminderville, OH (US); Samuel L. Belden, Chagrin Falls, OH (US); Jason A. Pasciak, Bedford Hts., OH (US); Daniel D. Runion, Charlotte, NC (US); Brian J. Hummer, Chagrin Falls, OH (US); Charles R. Middleton, Lyndhurst, OH (US); Vijay K. Paruchuri, Bellevue, WA (US)

(73) Assignee: Insurance.com Group, Inc., Solon, OH (US)

(21) Appl. No.: 13/153,298

(22) Filed: Jun. 3, 2011

Related U.S. Application Data
(60) Provisional application No. 61/351,039, filed on Jun. 3, 2010.

(51) Int. Cl. G06Q 40/08

(52) U.S. Cl. 705/4

(57) ABSTRACT

The invention provides a computer-implemented method of providing an insurance quotation to a prospect by associating the prospect with a profitability segment prior to providing the insurance quotation. The method further includes receiving identity information associated with the prospect and accessing at least one database using the identity information to generate a profitability score for the prospect. If the profitability score for the prospect meets a profitability threshold, then one or more second databases may be accessed to retrieve incident data and prior insurance data for the prospect and generating an insurance quotation based on the incident data and the prior insurance data retrieved from the one or more second databases. If the probability score for the prospect fails to meet the profitability threshold, then a process other than if the profitability score for the prospect meets the profitability threshold is executed.

### CROSS-REFERENCE TO RELATED APPLICATIONS

This application claims priority from U.S. Provisional Patent Application No. 61/351,039, filed on Jun. 3, 2010, all of which is incorporated herein by reference in its entirety.

### FIELD

The technology described herein relates generally to online sales and more particularly to increasing online sale conversions and increase profitability.

### BACKGROUND

For organizations that have some or all of their presence online, attracting prospects to the organization's website is only part of the formula for success. Once a prospect has been attracted to the website and enticed to begin a purchasing process, the organization must still retain the prospect through the purchasing process to convert the sale. If the prospect fails to complete the purchasing process, potential revenue for the organization may be lost.

Prospects may fail to complete the purchasing process for a number of reasons. For example, certain data prompts provided to the prospect may be confusing or the prospect may not be able or willing to provide answers to the data prompts. Additionally, requests for large amounts of data may result in prospect frustration or fatigue such that the prospect does not complete the purchasing process.

### SUMMARY

The invention provides a computer-implemented method of providing an insurance quotation to a prospect by associating the prospect with a profitability segment prior to providing the insurance quotation. The method further includes receiving identity information associated with the prospect and accessing at least one database using the identity information to generate a profitability score for the prospect. If the profitability score for the prospect meets a profitability threshold, then one or more second databases may be accessed to retrieve incident data and prior insurance data for the prospect and generating an insurance quotation based on the incident data and the prior insurance data retrieved from the one or more second databases. If the probability score for the prospect fails to meet the profitability threshold, then a process other than if the profitability score for the prospect meets the profitability threshold is automatically executed.

The method may further include that the one or more second databases may include a third-party database associated with a cost for access.

The method may further include that accessing the one or more second databases may retrieve a vehicle identification number, a driver's license number, an accident date, and a violation date for the prospect.

The method may further include that if the profitability score for the prospect fails to meet the profitability threshold, then one or more second databases may provide a prompt for incident data and prior insurance data for the prospect to the prospect, may receive incident data and prior insurance data from the prospect and may generate an insurance quotation based on the received incident data and the prior insurance data.

The method may further include that if the profitability score for the prospect meets the profitability threshold, one or more second databases may generate multiple car insurance quotations for multiple car insurance providers based on the incident data and the insurance data retrieved. If the profitability score for the prospect fails to meet the profitability threshold, one or more second databases may generate multiple car insurance quotations for multiple car insurance providers based on the incident data and the insurance data received from the prospect.

The method may further include said at least one database for retrieving the incident data may include a state motor vehicles records database.

The invention also provides a computer-implemented system for providing an insurance quotation to a prospect by associating the prospect with a profitability segment prior to providing the insurance quotation. The system further includes a data processor, a computer-readable memory encoded with instructions for commanding the data processor to execute steps including receiving identity information associated with the prospect. Identity information associated with the prospect may be received, and a first database may be accessed using the identity information to generate a profitability score for the prospect. If the profitability score for the prospect meets a profitability threshold, then one or more second databases may be accessed to retrieve incident data and prior insurance data for the prospect and may generate an insurance quotation based on the incident data and the prior insurance data retrieved from the one or more second databases. If the probability score for the prospect fails to meet the profitability threshold, then a process other than if the profitability score for the prospect meets the profitability threshold is executed.

The invention further provides a computer-readable memory encoded with instructions for commanding a data processor to execute steps including receiving identity information associated with the prospect. Identity information associated with the prospect may be received, and a first database may be accessed using the identity information to generate a profitability score for the prospect. If the profitability score for the prospect meets a profitability threshold, then one or more second databases may be accessed to retrieve incident data and prior insurance data for the prospect and may generate an insurance quotation based on the incident data and the prior insurance data retrieved from the one or more second databases. If the probability score for the prospect fails to meet the profitability threshold, then a process other than if the profitability score for the prospect meets the profitability threshold is executed.

### BRIEF DESCRIPTION OF THE DRAWINGS

FIG. 1 depicts a computer-implemented environment for providing a quotation to a prospect by associating the prospect with a profitability segment prior to providing the quotation.

FIG. 2 is a flow diagram depicting a process that may be utilized by a quote generator in generating a car insurance quote.

FIG. 3 is a block diagram depicting a process for providing a car insurance quotation that utilizes customer segmentation to provide an appropriate quote generating experience for a prospect.

FIG. 4 is a block diagram depicting a customer scoring process, where a prospect is associated with one of a plurality of customer segments.

FIG. 5 is a block diagram illustrating a process for generating a quote for a prospect.

FIG. 6 is a block diagram depicting a process for generating one or more insurance quotes.

FIG. 7 is a block diagram depicting details of an example Next interview process.

FIG. 8 is a flow diagram depicting a computer-implemented method for providing a car insurance quotation to a prospect by associating the prospect with a profitability segment prior to providing the car insurance quotation.

FIGS. 9A, 9B, and 9C depict example systems for providing a car insurance quotation to a prospect by associating the prospect with a profitability segment prior to providing the car insurance quotation.

FIG. 10 is a block diagram depicting data calls involving multiple databases.

### DETAILED DESCRIPTION

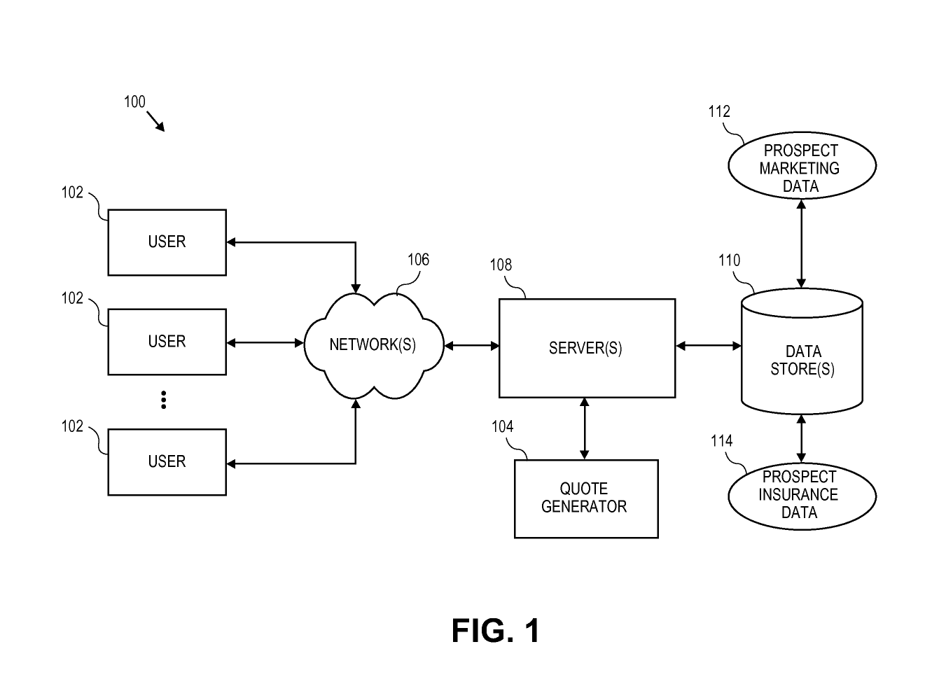

FIG. 1 depicts a computer-implemented environment for providing a quotation to a prospect by associating the prospect with a profitability segment prior to providing the quotation. A user 102 interacts with a quote generator 104 to receive a quotation for a purchase. The quote generator 104 may generate quotations for purchases of a variety of things including tangible items, services, as well as others.

For example, the quote generator 104 may be utilized to generate one or more car insurance quotations that may be accepted by a user 102 to purchase a car insurance policy for the user 102 and/or others. The quote generator may receive identification and/or other information associated with a user 102. Based on the information received, the quote generator 104 can determine a best method of providing a car insurance quote to the prospect user 102. For example, the quote generator 104 may use different methods for providing a car insurance quote to a user 102 based on the information received from the user 102. The quote generator 104 may also access one or more internal or external data sources to access additional prospect info for aiding in the determination of the best method for providing the car insurance quote to that user 102.

The users 102 can interact with the quote generator 104 through a number of ways, such as over one or more networks 106. Server(s) 108 accessible through the network(s) 106 can host the quote generator 104. One or more data stores 110 can store the data to be analyzed by the quote generator 104 as well as any intermediate or final data generated by the quote generator 104. The one or more data stores 110 may contain many different types of data associated with the process including prospect marketing data 112, prospect insurance data 114, as well as other data. The quote generator 104 can be an integrated web-based reporting and analysis tool that provides users flexibility and functionality for generating a quote. It should be understood that the quote generator 104 could also be provided on a stand-alone computer for access by a user 102. The quote generator may also be accessed by a user 102 through an intermediary, such as through an operator or automated system at a call center.

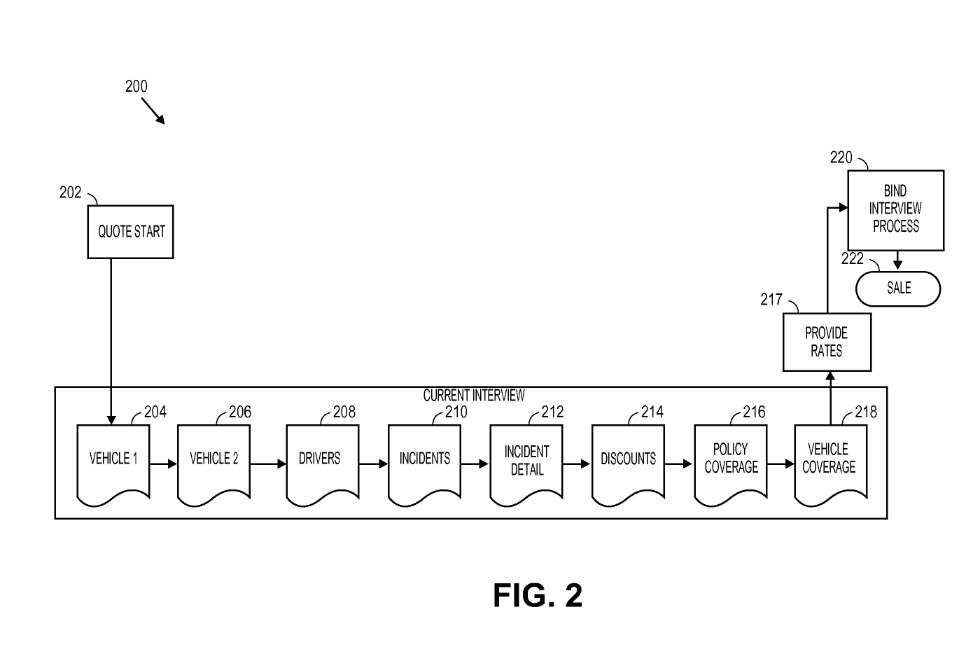

FIG. 2 is a flow diagram depicting a process that may be utilized by a quote generator in generating a car insurance quote. The depicted interview process 200 is often 5-7 or more pages in length. The process begins at 202 where a prospect may provide general information such as name, address, date of birth. At 204, the prospect is prompted for and enters data related to a first vehicle to be insured, and similarly, at 206, the prospect may enter data related to a second vehicle to be insured. At 208, the prospect is prompted for and enters data related to drivers to be insured under the requested policy. At 210, the prospect identifies any incidents, such as accidents or other losses, relevant to the vehicles or drivers to be insured, and at 212, further details on those incidents may be entered. At 214, data that could result in discounts may be entered by the prospect, such as standing as a safe driver under the prospect's current or previous car insurance policy. At 216, the prospect selects desired policy coverage such as injury and property loss coverage limits and coverage for uninsured/underinsured motorists, and at 217, the rates are provided. At 218, the prospect may select options for vehicle coverage such as deductible levels for collision and comprehensive claims as well as coverage limits. Based on the data entered by the prospect, one or more car insurance quotes are provided to the prospect at 220. For example, one or more quotes for a single car insurance provider may be provided or one or more quotes for each of a plurality of car insurance providers may be provided to the prospect at 220. The prospect selects a desired quote at 220 and a sale is completed at 222.

While the process depicted in FIG. 2 may often be successful in converting a car insurance sale, prospects may sometimes fail to complete the purchase of car insurance. For example, the prospect may be confused or frustrated with the lengthy set of forms prompting the prospect for data needed for underwriting the car insurance policies underlying the provided quotes. The prospect may also not know the correct or appropriate answers to some of the questions with which the prospect is prompted.

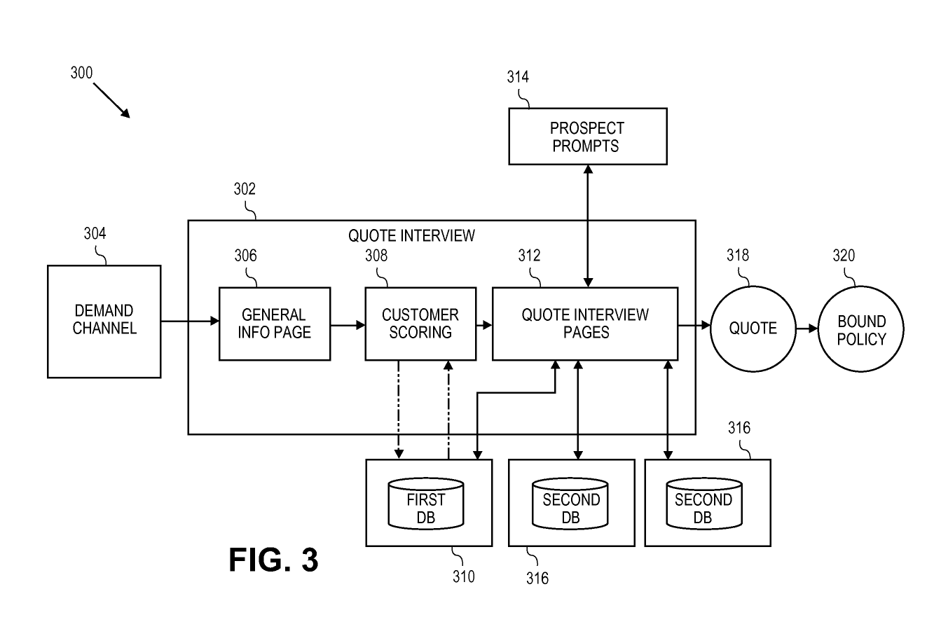

FIG. 3 is a block diagram depicting a process for providing a car insurance quotation that utilizes customer segmentation to provide an appropriate quote generating experience for a prospect. A prospect is directed to a quote generator and an associated quote interview 302 via a demand channel 304. For example, the prospect may be directed via a link from an affiliate, by entering an address into a web browser, via a search, or other method. A quote interview 302 begins at 306 where the prospect enters general information that may include identification information such as name, address, and date of birth.

The quote interview 302 continues with customer scoring at 308. The customer scoring 308 associates the prospect with one of a plurality of customer segments. For example, the customer scoring 308 may make a determination as to whether the prospect is likely to be a profitable customer or if the customer is likely to not be a profitable customer using a data model. The customer scoring 308 may utilize the information provided by the prospect using the general information page 306 for segmenting. Additionally, the customer scoring 308 may further rely on one or more internal or external first databases 310 for retrieving additional information related to the prospect. The additional information can be used by the customer scoring 308 to provide a more informed segmentation decision. The customer segmenting may be retained by the quote generator and reused for a period of time (e.g., 60 days) should the prospect return to restart or continue the quote generation process.

After the prospect is associated with a customer segment, the prospect navigates one or more quote interview pages 312. The quote interview pages 312 provided to the prospect may be tailored to the customer segment with which the prospect is associated by the customer scoring 308. For example, if the prospect is associated with the not likely to be profitable segment, then the prospect may be provided with a series of prompts 314 that require manual entry or different data needed for quote generator to provide a car insurance quote. For example, the prospect prompts 314 may be similar to those prompts described with respect to FIG. 2.

If the prospect is associated with the likely to be profitable segment, then the quote interview pages 312 may be tailored to streamline the data entry process. For example, some or all of the data required for generating the car insurance quote may be automatically accessed by the quote generator from one or more second databases 316 and/or the one or more first databases 310. For example, data associated with past car insurance coverage may be accessed to pre-fill vehicle and driver data, policy coverage limits, and vehicle coverage preferences. Data related to incidents and violations in which the prospect or drivers to be covered by the requested policy have been involved may also be accessed from the one or more databases 310, 316.

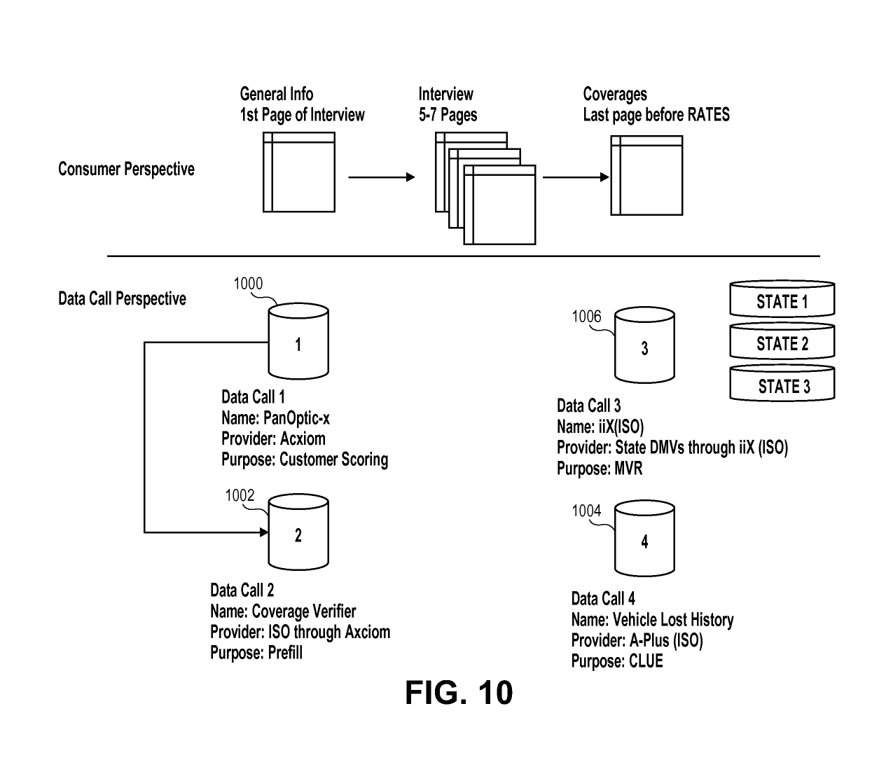

A number of different databases may be utilized as first and/or second databases 310, 316, as shown in FIGS. 3 and 10. For example, a database provided by Acxiom Corporation, such as PanOptic-X 1000, may be utilized as a first database 310 and/or one of the second databases 316. Other examples of databases that may be utilized include Insurance Services Office, Inc. (ISO) databases including Coverage Verifier 1002 for prior/current insurer data such as coverage limits (e.g., state minimum coverage or some values greater than minimum), policy add-ons, data regarding insured drivers and insured vehicles, and other current insurance parameters; ISO's A-Plus Vehicle Loss History 1004 for vehicle history and accident data; and state motor vehicle record databases (MVR) 1006 for incidents and violations related to vehicles and drivers to be covered under insurance policies associated with the quote to be generated (e.g., utilizing an aggregation service such as iiX that is configured to access each state's motor vehicle records). In summary for this example, database 1000 can be used within the system for customer scoring, database 1002 can be used for the purpose of pre-filling, database 1004 can be used for CLUE (e.g., financial reports on people and properties generated by a national insurance industry databank called Comprehensive Loss Underwriting Exchange), and database 1006 can be used for motor vehicle records information.

As an illustration, an Acxiom database may be utilized as a first database for a small cost, where, for prospects associated with the profitable segment, the ISO Coverage Verifier, ISO A+Vehicle Loss History, and state MVR databases are accessed to pre-fill fields of the quote interview pages 312. In one configuration, the second databases 316 utilized are accessed in order of ascending cost as the prospect accesses quote interview pages relevant to those accesses so that those accesses may not be performed if the prospect terminates the quote interview 302 prior to accessing the quote interview pages 312 associated with the more expensive cost-per-access second databases 316, saving the organization money.

Upon completion of the quote interview pages 312, whether via prospect prompts 314 or aided by database accesses, one or more car insurance quotes 318 may be provided to the prospect. The prospect may select a quote 318 and may garner a bound policy 320 based on the terms of the selected quote.

The segmenting of customers into a profitable customer segment and a not profitable customer segment and varying the quote interview pages according to the customer segment with which a prospect is associated may be advantageous to the organization providing a quote generator. Pre-filling some or all fields in the quote interview pages 312 streamlines the quote generation process. This streamlining may reduce prospect frustration and the time it takes to navigate the quote interview pages 312 and may increase accuracy of data provided to the quote generator. These advantages can make the quote interview pages more palatable to the prospect, making the prospect more likely to complete the quote interview pages 312 and convert an insurance sale.

However, pre-filling data for all prospects may not be in the best interests of the organization providing the insurance quotes. For example if the databases 310, 316 utilized by a quote generator in streamlining the quote interview pages 312 are pay-per-access, accessing those databases for prospects who are not likely to be profitable may result in higher costs than the benefits provided by increased conversions provided by the database aided quote interview pages. For example, if a prospect's expected profitability is $100, and the probability of a conversion for that prospect is expected to be increased 20% when the prospect is provided pre-filled out fields utilizing the pay-per-access databases, the use of the pay-per-access databases in the quote generation process has an expected value of $20. If the cost to access the pay-per-access databases is $25, then that is a poor expenditure by the organization. If the cost to access the pay-per-access databases is $10, then their use is a good expenditure. Thus, the customer scoring 308 may be adjusted accordingly, such that pay-per-access databases are utilized for prospects whose expected benefit is greater than the cost to access.

The first database 310 may be a free internal or other free database or may be a database having a nominal cost (e.g., less than 20%) compared to the cost of accessing other pay-per-access second databases 316. In this manner, the customer scoring 308 can access the first database 310 at little or no cost to better inform its profitability determination. This better informed profitability determination can then make a more accurate decision as to whether to provide the pay-per-access database 316 aided quote interview pages 312 or to require the prospect to manually enter data via the prospect prompts 314.

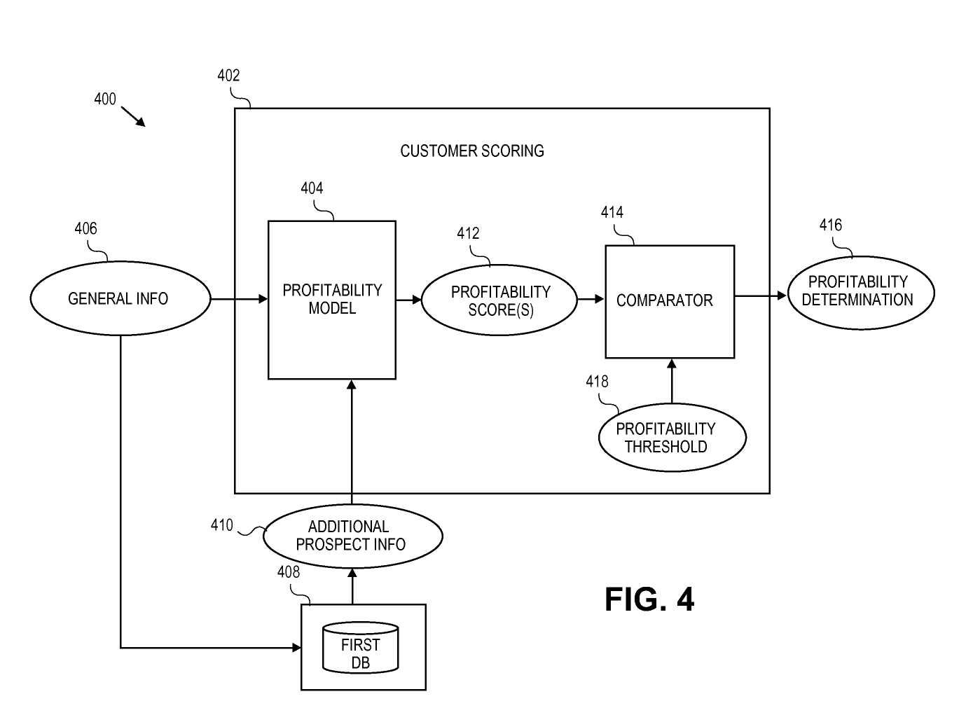

FIG. 4 is a block diagram depicting a customer scoring process, where a prospect is associated with one of a plurality of customer segments. The customer scoring 402 utilizes a profitability model 404 in the process of associating a prospect with a customer segment. The profitability model 404 is a data model that may be generated in a number of ways. For example, the profitability model may be generated based on a linear regression or multiple regression process, where historical correlations between a number of input variables related to a customer and the customer's eventual profitability are analyzed to identify those customer variables that most accurately predict profitability. Those customer variables may be selected and appropriately weighted to generate a model that provides a profitability score when provided one or more customer variables.

Profitability for historical customers for training the profitability model may be tailored to the organization providing the quote generator. For example, if the quote generator is being provided by an insurance provider, then the profitability for a historical customer may be based on the revenues provided by that customer to the insurance provider. If the organization providing the quote generator is an insurance marketplace that provides insurance quotes for multiple insurance providers, then the profitability for a historical customer may be based on the revenues provided by that customer to the insurance marketplace.

A number of customer variables may be considered in generating a profitability model. Those customer variables may include the identity data such as name, address, and date of birth. Additional customer variables may be accessed by queries to data sources such as outside databases. For example, the following variables may be accessible from an Acxiom Corporation database based on the identity information provided by a prospect: Age, Career, Education, Gender, Hobbies, Home Loan/Purchase, Income Range, and Number of Children.

Other methods of generating the profitability model may also be used. For example, a genetic algorithm may be used. The genetic algorithm selects a number of customer variables exhibiting a high degree of correlation with profitability to generate an initial model. The customer variables may then be varied in small steps to generate a new model that is compared to the initial model. The better of the two models is selected in a survival-of-the-fittest fashion. The variation and comparison may be performed over a number of iterations, seeking further improvements on the initial model. Other methods of data model generation may include decision tree modeling techniques as well as others.

With reference to FIG. 4, the profitability model 404 may receive one or more customer variables associated with a prospect seeking a quote. Some or all of those variables may be provided by the prospect via general information prompts 406. If additional customer variables are needed by the profitability model 404, those variables may be accessed from a data source such as an internal or external database 408 using the identity information included in the general information 406. Once the profitability model 404 has received the needed customer variables, one or more profitability scores 412 are generated and provided to a comparator 414, and a profitability determination 416 is made and output. If the profitability score 412 meets the profitability threshold 418, then the prospect may be associated with the profitable customer segment as a profitability determination 416. In contrast, if the profitability score 412 fails to meet the profitability threshold 418, then the prospect may be associated with the not profitable customer segment.

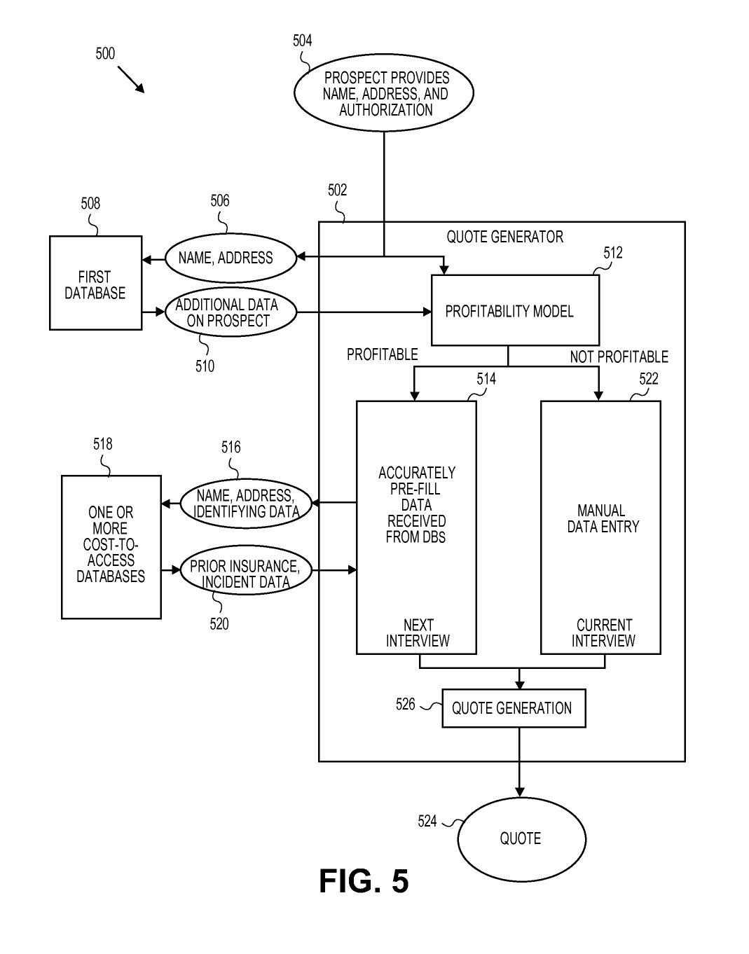

FIG. 5 is a block diagram illustrating a process for generating a quote for a prospect. A quote generator 502 receives prospect identity information that can include a name, address, date of birth, social security number, or other identifying information 504. The quote generator 502 may provide the prospect's name, address, and/or other identity information 506 to a first database 508. The first database 508 provides additional data 510 on the prospect to the profitability model 512 in response to the query 506. The profitability model 512 makes a determination as to whether the prospect should be segmented in the profitable or not profitable segments. If the prospect is associated with the profitable segment, then a database aided (“NEXT”) interview 514 experience is provided to the prospect that accurately pre-fills data received from databases. Name, address, and/or other identifying data 516 is provided to one or more cost-per-access databases 518, and supplemental data 520, such as prior insurance and incident data, is provided to the quote generator 502. In contrast, if the prospect is associated with the not profitable segment, then a manual data entry (“Current”) interview 522 experience is provided to the prospect. Following completion of the NEXT or Current Interviews 514, 522, a quote 524 is generated at 526 based on the data received from the interview 514, 522.

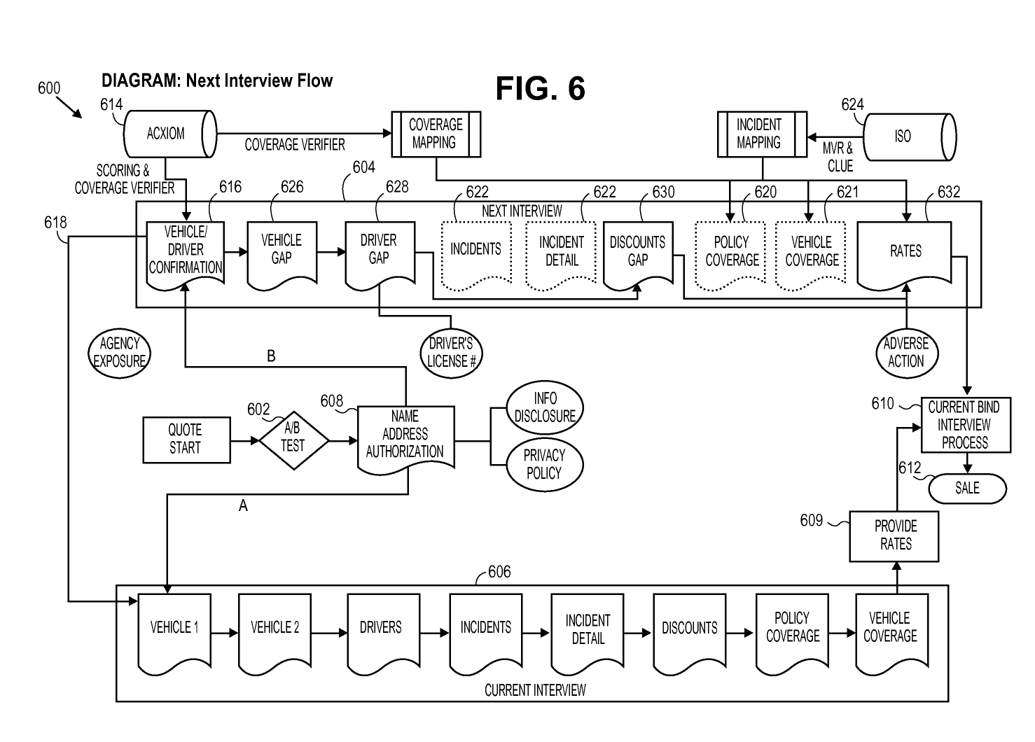

FIG. 6 is a block diagram depicting a process for generating one or more insurance quotes. The quote process begins at 602, where an A/B test is applied to a prospect. The A/B test is configured to direct a portion of the prospects to the NEXT interview process 604 and a portion of the prospects to the Current interview process 606. The A/B test may be implemented for a variety of purposes. For example, the A/B test may be used to test and phase in the Next interview process 604, where a prospect is permitted to traverse the B branch a small percentage of the time at first (e.g., 5%) for testing the Next interview process, and the percentage is increased upon successful testing to phase in the Next interview process 604, possibly to 100%. Even after testing and phase in of the Next interview process 604, a portion of prospects may still be directed to the Current interview process 606 to retain a control group for comparison of conversions between the Next interview process 604 and the Current interview process 606. At 608, identifying information such as the prospect's name and address are received from the prospect along with any authorizations necessary to access and/or request additional information from the prospect.

If the prospect is selected to take the “A” branch and receive the Current interview process 606 by the A/B test 602, then the prospect is provided a series of prompts for which the prospect must manually enter data. Following manual entry of data and the providing of rates at 608 the prospect may be provided one or more quotes at 610, and a sale may be converted at 612 based on one of the given quotes. A similar process is described in detail with respect to FIG. 2.

If the prospect is selected to take the “B” branch and receive the Next interview process 604, then the identity information provided by the prospect at 608 is used to access the Acxiom database 614 to access additional information used to generate a profitability score for the prospect. If the prospect is found in the Acxiom database, and the prospect confirms that the located records are his at 616, then a profitability determination is made for the prospect. If the prospect is associated with the not profitable customer segment, then the prospect is directed to the Current interview process 606, as indicated at 618.

If the prospect is associated with the profitable customer segment, then the prospect continues with the Next interview process 604. Data fields, such as vehicle/driver information 616, past policy data 620, vehicle coverage data 621, incident data 622, and other data may be pre-filled in the Next Interview process 604 based on data retrieved from one or more pay-peraccess databases such as the Acxiom database 614, the ISO database 624, as well as others. The prospect may enter additional data to fill in gaps in the data accessed from the pay-per-access databases. For example, the prospect may enter data related to additional vehicles to be covered 626, additional drivers to be covered 628, and data that may entitle the prospect to discounts 630. At 632, the data accessed from the databases along with additional data entered by the prospect are utilized to calculate rates 632 for quotes that are provided to the prospect at 610 for potential conversion at 612.

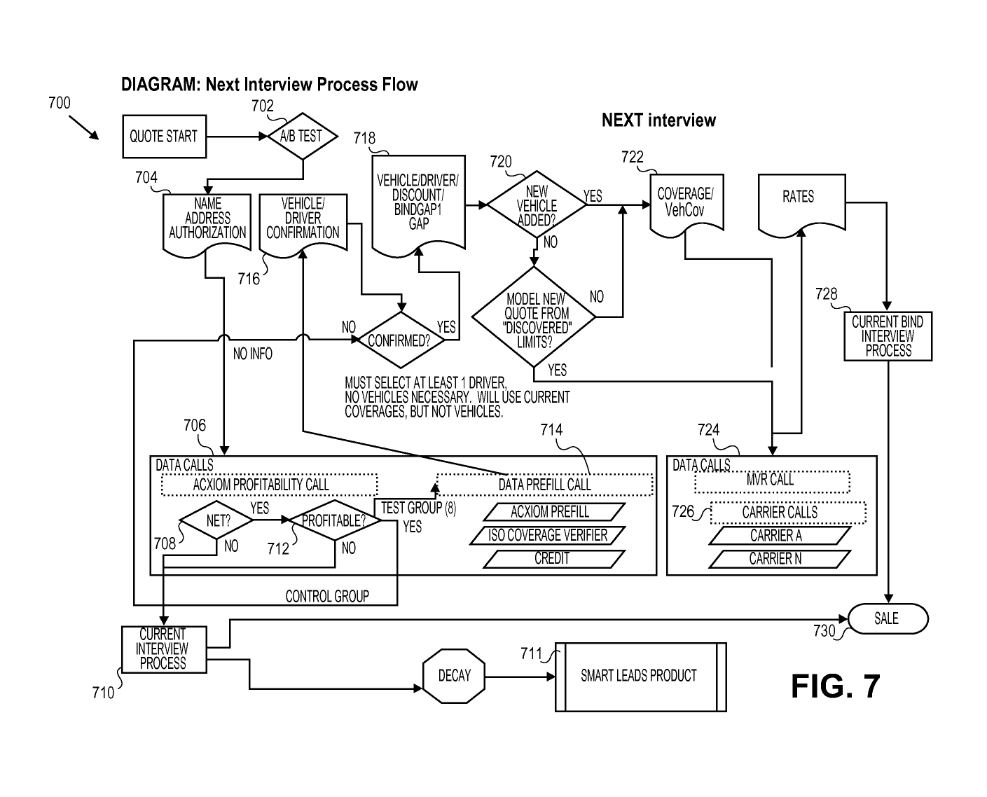

FIG. 7 is a block diagram depicting details of an example Next interview process. Following selection of the Next interview process via the A/B test 702, the prospect's name, address, and authorizations are received at 704. The identity information received is used to access the Acxiom database at 706 to attempt to access additional data for making a more informed profitability segmenting decision. If the prospect is not located in the Acxiom database at 708, then the prospect is directed to the manual entry Current interview process 710. A profitability segmenting decision is made at 712. If the prospect is deemed not to be profitable, then the prospect is directed to the Current interview process 710. Prospects who fail to complete the Current interview process 710 may be saved as leads 711, who may be pursued for business via other channels.

If the prospect is deemed profitable at 712, then the prospect continues the Next interview process. One or more queries to one or more additional databases, such as additional Acxiom databases, ISO databases, credit databases, and/or others, may be performed at 714 to access supplemental data for pre-filling fields in the Next interview process. At 716, the prospect confirms that the supplemental data is associated with the prospect. If the supplemental data is improperly attributed to the prospect, then the prospect may be directed to the Current interview process 710. If the prospect confirms the secondary data, then the prospect may enter gap information at 718. The gap information 718 may include additional data regarding vehicles and drivers to be covered by the quote that will be generated. Additional vehicles to be covered may be added at 720. Coverage preferences for the insurance quotes to be generated may be entered by the prospect at 722.

After the prospect has completed the Next interview process to step 722, the quote generator may initiate a query to one or more additional databases at 724, such as the MVR databases, to acquire additional data regarding the prospect's requested insurance quote. For example, the MVR database may be accessed to identify any incidents or violations associated with the prospect. Additionally, if the quote generator is to provide quotes for multiple insurance carriers, queries to those carriers may be performed at 726 based on the data acquired from the prospect and the one or more databases accessed. Based on this data, rates for the one or more quotes are generated at 728 and provided to the prospect at 728 with the potential to generate a car insurance sale 730.

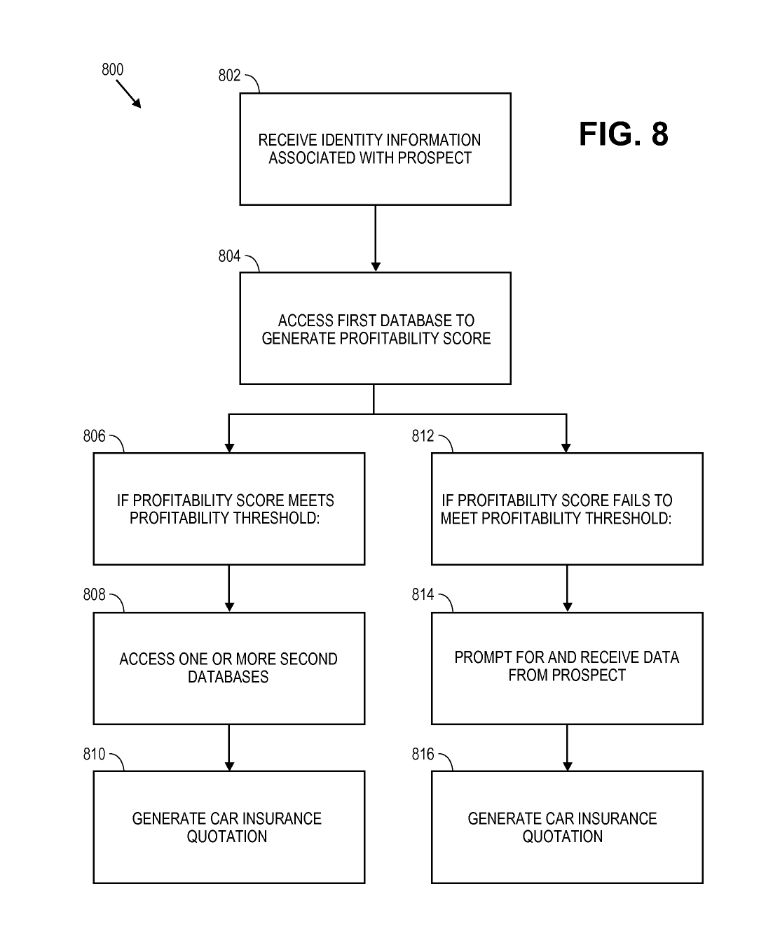

FIG. 8 is a flow diagram depicting a computer-implemented method for providing a car insurance quotation to a prospect by associating the prospect with a profitability segment prior to providing the car insurance quotation. Identity information associated with the prospect is received at 802, and a first database is accessed using the identity information at 804 to generate a profitability score for the prospect. If the profitability score for the prospect meets a profitability threshold at 806, then one or more second databases are accessed to retrieve incident data and prior insurance data for the prospect at 808, and a car insurance quotation is generated based on the incident data and the prior insurance data retrieved from the one or more second databases at 810. If the profitability score for the prospect fails to meet the profitability threshold at 812, then a prompt for incident data and prior insurance data for the prospect is provided to the prospect and incident data and prior insurance data are received from the prospect at 814, and a car insurance quotation is generated based on the received incident data and prior insurance data at 816.

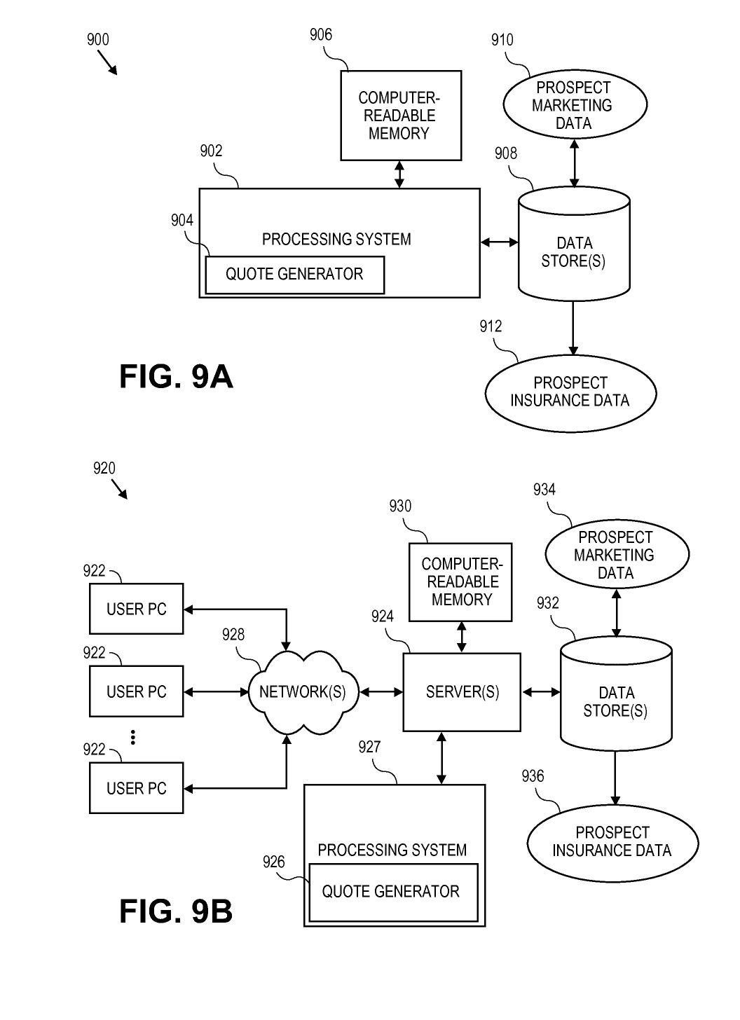

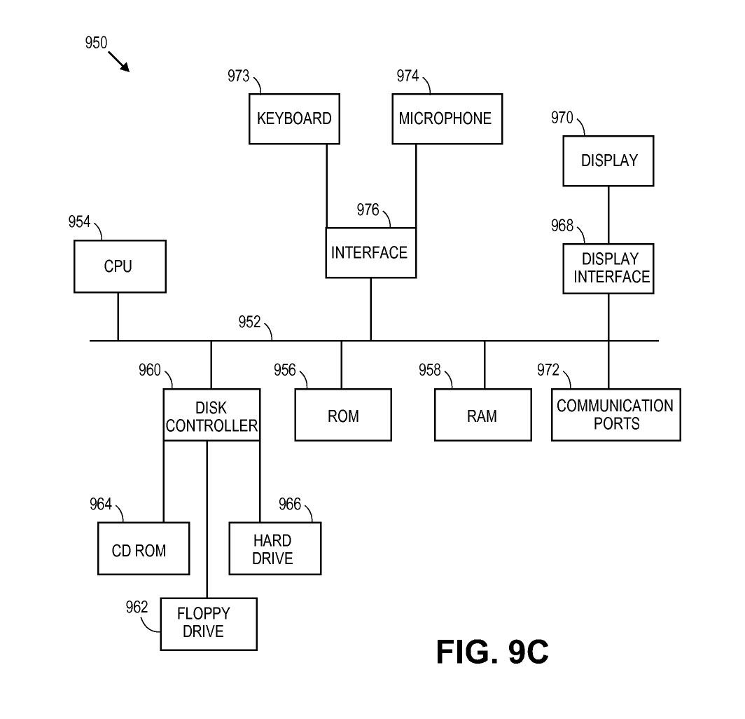

FIGS. 9A, 9B, and 9C depict example systems for providing a car insurance quotation to a prospect by associating the prospect with a profitability segment prior to providing the car insurance quotation. For example, FIG. 9A depicts an exemplary system 900 that includes a stand alone computer architecture where a processing system 902 (e.g., one or more computer processors) includes a system for generating a quote 904 being executed on it. The processing system 902 has access to a computer-readable memory 906 in addition to one or more data stares 908. The one or more data stores 908 may contain prospect marketing data 910 as well as prospect insurance data 912.

FIG. 9B depicts a system 920 that includes a client server architecture. One or more user PCs 922 accesses one or more servers 924 running a system for generating a quote 926 on a processing system 927 via one or more networks 928. The one or more servers 924 may access a computer readable memory 930 as well as one or more data stores 932. The one or more data stores 932 may contain prospect marketing data 934 as well as prospect insurance data 936.

FIG. 9C shows a block diagram of exemplary hardware for a stand alone computer architecture 950, such as the architecture depicted in FIG. 9A, that may be used to contain and/or implement the program instructions of system embodiments of the present invention. A bus 952 may serve as the information highway interconnecting the other illustrated components of the hardware. A processing system 954 labeled CPU (central processing unit) (e.g., one or more computer processors), may perform calculations and logic operations required to execute a program. A processor-readable storage medium, such as read only memory (ROM) 956 and random access memory (RAM) 958, may be in communication with the processing system 954 and may contain one or more programming instructions for providing a car insurance quotation to a prospect. Optionally, program instructions may be stored on a computer readable storage medium such as a magnetic disk, optical disk, recordable memory device, flash memory, or other physical storage medium. Computer instructions may also be communicated via a communications signal, or a modulated carrier wave.

A disk controller 960 interfaces with one or more optional disk drives to the system bus 952. These disk drives may be external or internal floppy disk drives such as 962, external or internal CD-ROM, CD-R, CD-RW or DVD drives such as 964, or external or internal hard drives 966. As indicated previously, these various disk drives and disk controllers are optional devices.

Each of the element managers, real-time data buffer, conveyors, file input processor, database index shared access memory loader, reference data buffer and data managers may include a software application stored in one or more of the disk drives connected to the disk controller 960, the ROM 956 and/or the RAM 958. Preferably, the processor 954 may access each component as required.

A display interface 968 may permit information from the bus 952 to be displayed on a display 970 in audio, graphic, or alphanumeric format. Communication with external devices may optionally occur using various communication ports 972.

In addition to the standard computer-type components, the hardware may also include data input devices, such as a keyboard 973, or other input device 974, such as a microphone, remote control, pointer, mouse and/or joystick.

Appendix A includes descriptions of use cases, pages provided to a prospect, and data sources that may be utilized by a quote generator.

This written description uses examples to disclose the invention, including the best mode, and also to enable a person skilled in the art to make and use the invention. The patentable scope of the invention may include other examples. For example, the systems and methods may include data signals conveyed via networks (e.g., local area network, wide area network, internet, combinations thereof, etc.), fiber optic medium, carrier waves, wireless networks, etc. for communication with one or more data processing devices. The data signals can carry any or all of the data disclosed herein that is provided to or from a device.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It may be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

APPENDIX A

| | |
|---|---|
| Use Case Description | Scenario |

Scoring and Testing Use Cases

| | |
|---|---|
| User is labeled an A | 1. User will be scored by Acxiom. |
| | 2. User will receive Current Interview. |
| User is labeled B and is scored as profitable | User will receive Next Interview |
| User is labeled B and is scored as unprofitable | User will receive Current Interview. |
| User comes to us from any of identified Lead Ags | 1. User will be scored by Acxiom. |
| (see below) | 2. User will receive Current Interview |

Acxiom Usage Use Cases

| | |
|---|---|
| User selects at least 1 driver from the Acxiom data | User is confirmed and will continue to gap pages. |
| User discards all returned Acxiom data | User will receive Current Interview. |
| (doesn't accept any drivers or vehicles) | |
| User selects vehicles but no drivers from Acxiom data | User is not confirmed and will receive Current Interview |
| MVR no hit | User will remain in Next Interview. |
| MVR hit, but there is no license status | User will remain in Next Interview and will be shown a |
| | page where they will be asked what the current license |
| | status is for the driver in question. This page will be just |
| | before rates. |
| We've infilled data from ISO Coverage Verifier and the | Any carriers not contributing to Coverage Verifier will be |
| consumer was sent from NextQuote to Current | KO'd. |
| Interview (for any reason). | |
| No-Hit From Acxiorn and user is B | User will receive Current Interview |
| User doesn't add all household drivers returned by | The system will disallow the user from selecting the |
| AddDriver | Insured but not selecting the spouse. (AddDriver returns |
| | relationship to applicant.) |
| If the policy returned by CoverageVerifier is already | Assume that the user's current policy is w/a non-ISO |
| expired and the user has said “Yes” to “Do you | participating carrier. |
| currently have insurance” | We will not show the Policy Effective Date on |
| | Driver/Vehicle confirmation. |
| | We will show the “discovered” |
| | BI/PD/COMP/COLL/UMUIM limits and ask . . . |
| | User will see the insurance page where we will |
| | have prefilled answers for current insurance info, |
| | and they will need to change if necessary and |
| | enter Policy Start Date. |

Interview Flow Use Cases

| | |
|---|---|
| User modifies any RC1 data | Re-run rates. |
| User adds a driver not returned by AddDriver. | New MVR is run for the new driver and rates are re-run. |
| | DL state and DL# on the Driver gap. |
| User adds a vehicle not returned by AddVehlcle | User will have entered the vehicle information prior to |
| | RC1, and will be required to enter a VIN in bind. |
| Use needs to Add a Driver/Vehicle | Can be done 1 of three ways: |
| | 1. From the Drv/Veh confirmation page by selecting |
| | yes to “Do you want to add . . .” question |
| | 2. From the Driver and/or Vehicle gap pages. |
| | 3. By clicking the “Add” buttons on the Quote |
| | Summary Panel |
| RC2 | All users will see the current “B version” of the payment |
| | page. This should eliminate the need for any Rate Change |
| | messaging. |
| Consumer sees rates and wants to modify | Consumer will click an “Edit” button on the Quote |
| | Summary panel and be taken to the equivalent “gap” |
| | page. Only those fields that were shown the first time the |
| | consumer saw the page will be shown. Upon completing |
| | their changes they will be “fast forwarded” to rates w/a |
| | new rate call |
| Consumer sees rates and wants to change their | There will be buttons on the Rates page (similar to Short |
| coverages | Quote POC) that will let the consumer see “one up” or |
| | “one down” from the original/current quote. The system |
| | will change the coverage amount defaults and re-run the |
| | rate call. If the user is already at the highest/lowest |
| | coverage amount then the equivalent button will not be |
| | shown. |
| User is sent to Current interview after we've retrieved | Liberty and Esurance will not receive this data. We will |
| Coverage Verifier data from Acxiom. | prevent by carrier KO. |
| If the user accepts at least 1 driver and 1 vehicle from | We will make assumptions and use defaults for the |
| the Acxiom returned data | questions on the Gap pages, skip the gaps pages, and |
| | show rates. If the user continues from there to the |
| | purchase process they'll be sent to the gap pages. |
| If the user doesn't select at least 1 driver and 1 vehicle | They will be sent to Current Interview as we assume that |
| from the Acxiom returned data | the infilled data is not the customer's. |
| If Acxiom comes back with you and your spouse but | User will be sent to the Gap pages where they'll be able |
| you don't select the spouse, | to adjust marital status and/or add a spouse. |

Retrieve Use Cases

| | |
|---|---|
| User does a NextQuote and then retrieves later | User will remain in Next Quote until some other use case |
| | knock's them out. |
| | Upon retrieve user will see a “Please wait” popup, rate |
| | call will be made, and rates displayed unless there are |
| | unanswered questions or edits that have been fired due |
| | to the passage of time (a la effective dates) then Fast- |
| | Forwarded as much as possible. |
| If there is more than one session available to be | The NextQuote session will take precedence. |
| retrieved . . . | |
| User does a retrieve | NextQuote will process this. |
| SC Retrieve | Upon customer lookup, there will be an indicator on the |
| | Customer Profile page telling the agent that it is a Next |
| | Quote. |
| | Next Quote will trump the other quotes available and the |
| | row will be highlighted for the agent in the system. |
| | Agent selects the NextQuote and is Smart Landed as far as |
| | possible up to and including the Rates page. |
| | Session copy should always be from Next Quote to new |
| | quote. Imported data is always assumed to be best. |

Pages

| Page Name | Rules and Description |
|---|---|
| General Info | Will be exactly the same for both Next Interview and |
| | Current Interview |
| Driver/Vehicle Confirmation | Will display only for Next Interview and will contain: |
| | Driver(s) |
| | First Name |
| | Last Name |
| | DOB in (xx/xx/1977) format for privacy |
| | Vehicles |
| | Discovered |
| | Limits: |
| | BI |
| | PD |
| | Comp |
| | Coll |
| | UMUIM |
| | Current Expiration date |
| | We will ask the following questions: |
| | How the Named Insured knows each driver |
| | When they want the current policy to start |
| | Using a DatePicker |
| | Restrict dates so not to create a lapse |
| | Dependant on “discovering” a policy |
| | that is currently in force. |
| | Which Vehicles/Drivers they want to include on |
| | the quote |
| | If they want the quote to assume coverages that |
| | are as close as possible to the discovered policy. |
| | If they want to add more drivers/vehicles. |
| Vehicle Gap | Vehicle 1 page will be skipped. |
| | Vehicle 2 page will contain the “Gap” questions. This |
| | includes: |
| | Annual mileage |
| | Commuting distance |
| | Days Driven |
| | Vehicle registration |
| | We will hide the question “Do you need to add a vehicle” |
| | b/c the user has just answered that question on the |
| | Driver/Vehicle Confirmation page. |
| Driver Gap | We will hide the question “Do you need to add a driver” |
| | b/c the user has just answered that question on the |
| | Driver/Vehicle Confirmation page. |
| Discounts | Will contain |
| | DVA |
| | # of Household residents |
| | Do you own a MC or Boat? |
| | Member of AAA? |
| | Driver improvement course? |
| | Residential insurance? |
| Insurance | Will only be shown if the Coverage Verifier policy is for a |
| | policy not currently in force. |
| Coverages and VehCov | Will only be shown if the consumer indicates that they DO |
| | NOT want the quote to be modeled after the discovered |
| | policy. |
| RC1 popup | Will only display carriers that are in play for Next |
| | Interview |
| Rates | Rates page may look like today, however it may have a |
| | way for users to increase/decrease coverages with one |
| | click. |
| | We may show some type of Adverse Action scripting. |
| First Page of Bind | No changes |
| Profile and Info | VIN and Driver's License #'s will not be displayed as they |
| | will have been infilled from Acxiom or previously entered |
| | by users (in the case of adding a drv/veh not discovered) |
| Payment | No changes. There will still be a RC2 |

It is claimed:

1. A computer-implemented method of providing an insurance quotation to a prospect by associating the prospect with a profitability segment prior to providing the insurance quotation, the method comprising:
receiving identity information associated with the prospect;
accessing at least one database using the identity information to generate a profitability score for the prospect;
if the profitability score for the prospect meets a profitability threshold:
accessing said at least one second database to retrieve incident data and prior insurance data for the prospect; and
generating an insurance quotation based on the incident data and the prior insurance data retrieved from the one or more second databases; and
if the probability score for the prospect fails to meet the profitability threshold automatically executing a process other than if the profitability score for the prospect meets the profitability threshold.

2. The method of claim 1, wherein the one or more second databases include a third-party database associated with a cost for access.

3. The method of claim 1, wherein accessing the one or more second databases retrieves: a vehicle identification number, a driver's license number, an accident date, and a violation date for the prospect.

4. The method of claim 1, further comprising:
if the profitability score for the prospect fails to meet the profitability threshold:
providing a prompt for incident data and prior insurance data for the prospect to the prospect; and
receiving incident data and prior insurance data from the prospect; and
generating an insurance quotation based on the received incident data and the prior insurance data.

5. The method of claim 4, further comprising:
if the profitability score for the prospect meets the profitability threshold:
generating multiple car insurance quotations for multiple car insurance providers based on the incident data and the insurance data retrieved from the one or more second databases;
if the profitability score for the prospect fails to meet the profitability threshold:
generating multiple car insurance quotations for multiple car insurance providers based on the incident data and the insurance data received from the prospect.

6. The method of claim 1, wherein said at least one database for retrieving the incident data includes a state motor vehicles records database.

7. A computer-implemented system for providing a insurance quotation to a prospect by associating the prospect with a profitability segment prior to providing the insurance quotation, the system comprising:
a data processor;
a computer-readable memory encoded with instructions for commanding the data processor to execute steps including:
receiving identity information associated with the prospect;
accessing at least one database using the identity information to generate a profitability score for the prospect;
if the profitability score for the prospect meets a profitability threshold:
accessing said at least one database to retrieve incident data and prior insurance data for the prospect; and
generating an insurance quotation based on the incident data and the prior insurance data retrieved from the one or more second databases; and
if the probability score for the prospect fails to meet the profitability threshold automatically executing a process other than if the profitability score for the prospect meets the profitability threshold.

8. A computer-readable memory encoded with instructions for commanding a data processor to execute steps including:
receiving identity information associated with the prospect;
accessing at least one database using the identity information to generate a profitability score for the prospect;
if the profitability score for the prospect meets a profitability threshold:
accessing said at least one second database to retrieve incident data and prior insurance data for the prospect; and
generating an insurance quotation based on the incident data and the prior insurance data retrieved from the one or more second databases; and
if the probability score for the prospect fails to meet the profitability threshold automatically executing a process other than if the profitability score for the prospect meets the profitability threshold.
